(19) United States
(12) Patent Application Publication
(10) Pub. No.: US 2022/0093046 A1
(43) Pub. Date: Mar. 24, 2022

(54) Light Emitting Scanning Drive Unit, Array Substrate and Method for Outputting Light Emitting Scanning Signal

(71) Applicant: SHENZHEN ROYOLE TECHNOLOGIES CO., LTD., Shenzhen, Guangdong (CN)

(72) Inventor: Yao Yan, Shenzhen (CN)

(21) Appl. No.: 17/424,885

(22) PCT Filed: Jan. 22, 2019
(86) PCT No.: PCT/CN2019/072646

§ 371 Date: Jul. 22, 2021

(51) Int. Cl. G09G 3/3266

(52) U.S. Cl. CPC G09G 3/3266; G09G 2330/021; G09G 2300/0408; G09G 2310/08

(57) ABSTRACT

Provided is a light emitting scanning drive unit (EOA), including a pull-up control unit (11), a pull-up output unit (12), a pull-down control unit (14) and a pull-down output unit (13). When receiving a first clock signal (ECKi), the pull-up control unit (11) transmits the high-level reference voltage to the pull-up node (PU) to control the pull-up point (PU) to be in the high-level state, meanwhile, the pull-up output unit (12) transmits the high-level reference voltage to the light emitting scanning terminal (Oe) when it is in the high-level state and outputs the high-level reference voltage as the light emitting scanning signal. The pull-down control unit (14) is electrically connected to the pull-down node (PD) and the pull-up node (PU), controls the pull-up node (PU) to be in the low-level state and the pull-down node (PD) to be in the high-level state in two non-overlapping time periods within one scanning period, the pull-down output unit (13) outputs the low-level reference voltage to the light emitting scanning terminal (Oe) when the pull-down node (PD) is in the high-level state.

### TECHNICAL FIELD

The present disclosure relates to the field of display driving, in particular to the scanning driving technology in image display.

### BACKGROUND ART

In an image display process of self-luminous display panel, a scan drive circuit is required to provide a gate scanning signal to cooperate with a light emitting scanning signal, and a data drive circuit is required to provide an image data signal to drive a pixel array arranged in an image display area to perform image display. In recent years, in order to improve the integration level of display panel, a gate scan drive circuit, a light emitting scan drive circuit, and a pixel array are fabricated together on an array substrate, also called as GOA (Gate on Array, gate driving array substrate) and EOA (Emission on Array) circuits.

Each scan drive circuit includes a plurality of scanning drive units, which are usually designed in a cascade manner so as to sequentially output shifted scanning signals to the pixel array. In the above, each scanning drive unit includes one GOA circuit and one EOA circuit. However, the existing GOA circuit and EOA circuit may generate a phenomenon of large power consumption of the pixel unit in the process of actually driving the pixel unit to perform an image display operation.

### SUMMARY

In order to solve the preceding problems, a light emitting scanning drive unit with low power consumption is provided.

Further, an array substrate including the preceding light emitting scanning drive unit is further provided.

An embodiment of the present disclosure discloses a light emitting scanning drive unit. The light emitting scanning drive unit includes:

a pull-up control unit, configured to receive a first clock signal, and transmit a high-level reference voltage to a pull-up node, according to the first clock signal in one scanning cycle, so as to control the pull-up node to be in a high-level state;

a pull-up output unit, electrically connected to the pull-up node, and transmitting, when the pull-up node is in the high-level state, the high reference voltage received to a light emitting scanning terminal and outputting the high reference voltage as the light emitting scanning signal;

a pull-down control unit, electrically connecting a pull-down node and the pull-up node, and configured to control the pull-up node to be in a low-level state and to control the pull-down node to be in a high-level state in two non-overlapping time periods in one scanning cycle; and

a pull-down output unit, electrically connected to the pull-down node and the light emitting scanning terminal, and configured to, when the pull-down node is in the high-level state, output a low-level reference voltage received to the light emitting scanning terminal and output the low-level reference voltage as the light emitting scanning signal.

An embodiment of the present disclosure discloses an array substrate. The array substrate includes a pixel unit and a scan drive circuit, wherein the scan drive circuit includes a plurality of scanning drive units cascaded with each other, the scanning drive unit includes a gate scanning drive unit and the preceding light emitting scanning drive unit. The gate scanning drive unit is configured to output the gate scanning signal, and the pixel unit, driven by the gate scanning signal and the light emitting scanning signal, emits light for a data signal received and performs image display.

An embodiment of the present disclosure further discloses a method for outputting the light emitting scanning signal with the preceding light emitting scanning drive unit, including:

providing, corresponding to the initialization time period of the pixel unit, the gate scanning signal at a high level to the pull-down control unit so as to control the pull-down node to be in a high-level state, wherein when the pull-down node is in a high-level state, the pull-down output unit outputs the low-level reference voltage received to the light emitting scanning terminal;

providing, corresponding to the compensation time period of the pixel unit, the second clock signal at a high level to the pull-down control unit so as to control the pull-down node to be in a low-level state and control the pull-up node to be in a high-level state, wherein when the pull-up node is in a high-level state, the pull-up output unit transmits the high-level reference voltage to the light emitting scanning terminal;

providing, corresponding to the data loading time period of the pixel unit, the gate scanning signal at a high level to the pull-down control unit so as to control the pull-down node to be in a high-level state, wherein when the pull-down node is in a high-level state, the pull-down output unit outputs the received low-level reference voltage to the light emitting scanning terminal; and

providing, corresponding to the light emitting time period of the pixel unit, the first clock signal to the pull-up control unit so as to control the pull-up node to be in a high-level state, wherein when the pull-up node is in a high-level state, the pull-up output unit outputs the high-level reference voltage received to the light emitting scanning terminal.

Compared with the prior art, in the corresponding initialization time period and data loading time period of the pixel unit, the light emitting scanning drive unit provides the light emitting scanning signal at a low level, therefore, in the initialization time period, the light emitting scanning signal can control the pixel transistor that receives the drive voltage to be in an off state, thus it can effectively ensure that a drive voltage terminal and an initialization voltage terminal are in an electrically disconnected state therebetween, that is, the two cannot form a conductive path, thus effectively reducing the power consumption of each transistor and each capacitance element.

### BRIEF DESCRIPTION OF DRAWINGS

In order to more clearly illustrate technical solutions in embodiments of the present disclosure, accompanying drawings which need to be used in the embodiments will be introduced briefly below, and apparently, the accompanying drawings in the description below merely show some embodiments of the present disclosure, and a person ordinarily skilled in the art still could obtain other drawings in light of these accompanying drawings, without using inventive efforts.

FIG. 1 is a schematic diagram of a layout structure of a scan drive circuit in an embodiment of the present disclosure;

FIG. 2 is a schematic diagram of a circuit structure of a pixel unit as shown in FIG. 1;

FIG. 3 is a schematic diagram of an operation phase of the pixel unit as shown in FIG. 2; and

FIG. 4 is a schematic diagram of a circuit structure of a light emitting scanning drive unit as shown in FIG. 1;

FIG. 5 is an operation sequence diagram of a light emitting scan drive circuit as shown in FIG. 1 and FIG. 4;

FIG. 6 is a schematic flow chart of outputting a light emitting scanning signal by the light emitting scan drive circuit shown in FIG. 1 and FIG. 4; and

FIG. 7 is an operation sequence diagram of the pixel unit shown in FIG. 2.

### DETAILED DESCRIPTION OF EMBODIMENTS

The technical solutions in the embodiments of the present disclosure will be described clearly and completely below in conjunction with the accompanying drawings in the embodiments of the present disclosure, and apparently, some but not all embodiments of the present disclosure are described. All of other embodiments, obtained by those ordinarily skilled in the art based on the embodiments of the present disclosure without using any inventive efforts, shall fall into the scope of protection of the present disclosure.

The circuit structures of the light emitting scanning drive unit and the array substrate containing the light emitting scanning drive unit and the operation process thereof are specifically described below in conjunction with the accompanying drawings.

All of the transistors adopted in all embodiments of the present disclosure are N-type thin-film transistors (TFT) manufactured by indium gallium zinc oxide (IGZO) process or low temperature poly-silicon (LTPS). Certainly, in other modified embodiments, the transistors may also be P-type thin-film transistors, but not limited thereto, and a pixel unit is an organic light-emitting diode (OLED) display unit.

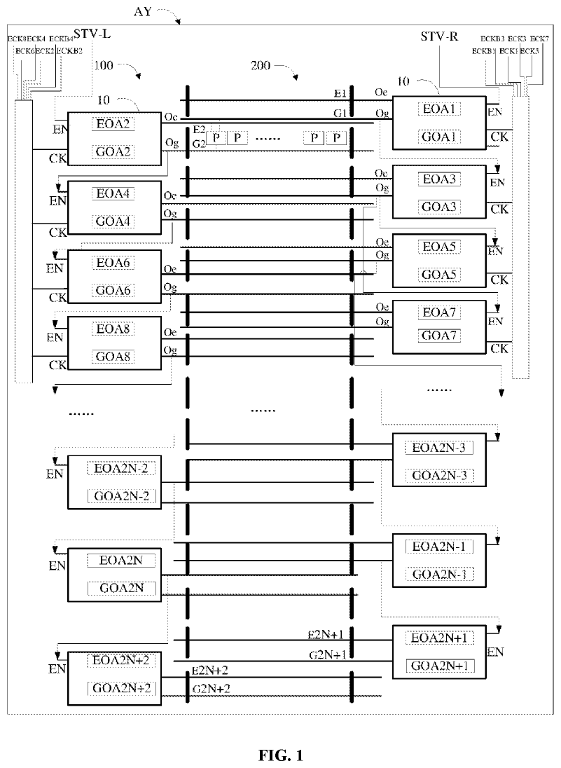

Referring to FIG. 1, it is a schematic diagram of a layout structure of an array substrate AY in an embodiment of the present disclosure.

As shown in FIG. 1, the array substrate AY includes a pixel matrix 200 provided in a display area and a scan drive circuit 100 provided in a non-display area, wherein the scan drive circuit 100 is configured to provide a scanning pulse signal to the pixel matrix 200.

The scan drive circuit 100 includes a plurality of scanning drive units 10 cascaded with each other, and the plurality of scanning drive units 10 cascaded with each other are respectively connected to a plurality of groups of scanning lines for providing scanning signals sequentially to the plurality of groups of scanning lines in the pixel array 200, wherein each group of scanning lines includes one gate scanning line Gk and one light emitting scanning line Ek, where k is any positive integer greater than 1 and smaller than 2N+2. Correspondingly, each scanning drive unit 10 provides a gate scanning signal and a light emitting scanning signal to the gate scanning line and the light emitting scanning line corresponding to the scanning drive unit. In the above, each scanning drive unit 10 outputs the gate scanning signal and the light emitting scanning signal of one scanning cycle to a group of scanning lines connected to the scanning drive unit 10 in the driving display of one frame of image.

In the present embodiment, each scanning drive unit 10 includes a gate scanning drive unit GOA and a light emitting scanning drive unit EOA. In the above, the gate scanning drive unit GOA is configured to output the gate scanning signal, and the light emitting scanning drive unit EOA is configured to output the light emitting scanning signal. A plurality of pixel units P in each row, under cooperative driving of the gate scanning signal and the light emitting scanning signal, performs light emitting display according to image data to be displayed, so as to display the image to be displayed.

The plurality of scanning drive units 10 are defined in two parts, which are arranged on two opposite sides of the pixel array 200, respectively. Specifically, each row of pixel units P correspond to one scanning drive unit 10, one gate scanning line Gk and light emitting scanning line Ek, respectively, and the scanning drive units corresponding to two adjacent gate scanning lines and two adjacent light emitting scanning lines are provided at two opposite sides of the pixel array 200, respectively, that is, the scanning drive units 10 corresponding to odd rows of scanning lines and even rows of scanning lines are located at two opposite sides of the pixel array 200, respectively. For example, taking the gate scanning lines as an example, gate scanning drive units GOA1, GOA3, GOA5, GOA7 . . . GOA(N−2), GOAN, GOA(N+2) . . . corresponding to odd rows of gate scanning lines G1, G3, G5 . . . are located on a right side of the pixel array 200; and scanning drive units GOA2, GOA4, GOA6, GOA8 . . . GOA(N−3), GOA(N−1), GOA(N+1) . . . corresponding to even rows of gate scanning lines G2, G4, G6 . . . are located on a left side of the pixel array 200. Taking the light emitting scanning lines as an example, light emitting scanning drive units EOA1, EOA3, EOA5, EOA7 . . . EOA(N−2), EOAN, EOA(N+2) . . . corresponding to odd rows of light emitting scanning lines E1, E3, E5 . . . are located on the right side of the pixel array 200; and light emitting scanning drive units EOA2, EOA4, EOA6, EOA8 . . . EOA(N−3), EOA(N−1), EOA(N+1) . . . corresponding to even rows of light emitting scanning lines E2, E4, E6 . . . are located on the left side of the pixel array 200.

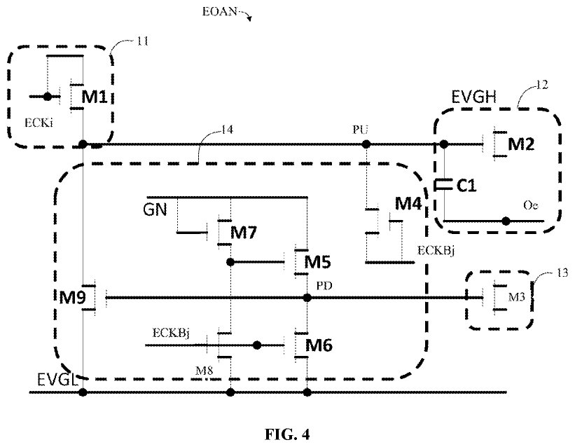

In the above, each scanning drive unit 10 includes a driving enabling terminal EN, a clock signal terminal CK, a gate scanning terminal Og, and a light emitting scanning terminal Oe. When the light emitting scanning terminals are cascaded with each other, the scanning drive units corresponding to the odd rows of scanning lines are cascaded in sequence, and the scanning drive units 10 corresponding to the even rows of scanning lines are cascaded with each other in sequence. In the above, the driving enabling terminal EN in each scanning drive unit 10 is configured to receive a startup voltage STV, and provide the startup voltage STV to the gate scanning drive unit GOA in the scanning drive unit 10. The clock signal terminal CK is configured to receive a plurality of clock signals provided externally. In the present embodiment, the clock signal terminal in each scanning drive unit 10 includes a first clock signal terminal ECK (FIG. 4) and a second clock signal terminal ECKB (FIG. 4), and two clock signals, i.e. a first clock signal ECKi and a second clock signal ECKBj, are received from the two clock signal terminals, respectively, where i is a positive integer smaller than 8, and j is a positive integer smaller than 4. The gate scanning drive unit GOA outputs the gate scanning signal to the corresponding gate scanning line Gk through the gate scanning terminal Og, and the light emitting scanning drive unit EOA outputs the light emitting scanning signal to the corresponding light emitting scanning line Ek through the light emitting scanning terminal Oe.

Specifically, taking the scanning drive units 10 corresponding to the odd rows of scanning lines as an example, that is, taking a plurality of scanning drive units 10 on the right side in FIG. 1 as an example, the driving enabling terminal EN of the gate scanning drive unit GOA1 in the scanning drive unit 10 located in a first position is connected to a startup voltage terminal STV-R so as to receive the startup voltage STV (not marked), and the gate scanning terminal Og, while being connected to a first scanning line G1, is also electrically connected to the driving enabling terminal EN of the GOA3, and so on. Correspondingly, for a plurality of scanning drive units 10 on the left side, the driving enabling terminal EN of the GOA2 is connected to a startup voltage terminal STV-L so as to receive the startup voltage STV, and the gate scanning terminal Og, while being connected to the second scanning line G2, is also electrically connected to the driving enabling terminal EN of the GOA4, and so on.

In the scan drive circuit 100, each eight adjacent light emitting scanning drive units EOA are in a group according to arranged positions, and receive eight first scanning clock signals ECK1-ECK8 in adjacent scanning cycles, respectively, and meanwhile, each four adjacent light emitting scanning drive units EOA are in a group and receive four second scanning clock signals ECKB1-ECKB4 in adjacent scanning cycles, respectively. In the present embodiment, four light emitting scanning drive units EOA are set as a group according to arranged positions on both left and right sides, and receive four first scanning clock signals ECKi and two second scanning clock signals ECKBj, respectively.

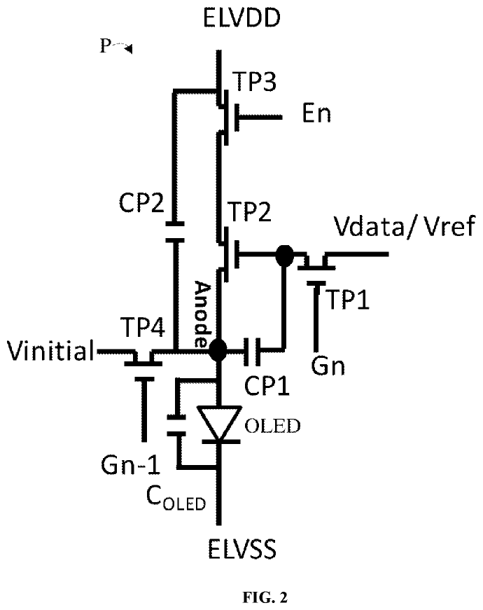

Specifically, referring to FIG. 2, it is a schematic diagram of a circuit structure of any pixel unit P in the pixel matrix 200 as shown in FIG. 1. The pixel matrix 200 includes several pixel units P distributed in an array and configured to perform image display. As shown in FIG. 2, any pixel unit P in an n-th row is a drive circuit structure of 4T2C driving OLED display composed of four transistors and two capacitors.

Specifically, the pixel unit P includes a first pixel transistor TP1, a second pixel transistor TP2, a third pixel transistor TP3, a fourth pixel transistor TP4, a drive capacitor CP1, and an auxiliary capacitor CP2.

In the above, the first pixel transistor TP1 has a gate electrically connected to the gate scanning line Gn, a drain electrically connected to a data line (not marked) so as to receive a data signal Vdata/Vref, and a source electrically connected to a gate of the second pixel transistor TP2.

The third pixel transistor TP3 has a gate electrically connected to the light emitting scanning line En, a drain electrically connected to a drive voltage terminal ELVDD, and a source electrically connected to a drain of the second pixel transistor TP2.

The second pixel transistor TP2 has a source electrically connected to an anode terminal Anode of a light emitting element OLED.

The four pixel transistor TP4 has a gate electrically connected to the gate scanning line Gn−1, a drain electrically connected to an initialization voltage terminal Vinitial, and a source electrically connected to the anode terminal Anode of the light emitting element OLED. In the above, the initialization voltage terminal Vinitial is configured to provide an initialization voltage Vini.

The drive capacitor CP1 is electrically connected between the anode terminal Anode of the light emitting element OLED and the gate of the second pixel transistor TP2.

The auxiliary capacitor CP2 is electrically connected between the anode terminal Anode of the light emitting element OLED and a high-voltage drive terminal ELVDD.

A cathode of the light emitting element OLED is electrically connected to a low-voltage drive terminal ELVSS.

For the pixel unit P in the n-th row, the selection of the pixel unit needs to be performed by receiving the gate scanning signals from the gate scanning lines Gn and Gn−1, and meanwhile loading of image data Vdata is performed by receiving the light emitting scanning signal from the light emitting scanning line En. That is, each pixel unit P needs cooperation of at least three scanning signals to be able to accurately perform correct display of image data.

Meanwhile, in order to accurately perform the display of image data, the pixel unit P includes an initialization time period (Initial) t1, a compensation time period (Com) t2, a data loading time period (Data) t3, and a light emitting time period (Emission) t4 which are continuous in time without intervals/interruption in one scanning cycle, that is to say, the initialization time period t1, the compensation time period t2, the data loading time period t3, and the light emitting time period t4 are continuous in time without intervals or overlapping. In the above, one scanning cycle of the pixel unit P is an operation cycle of the pixel unit P in a process of displaying one frame of image.

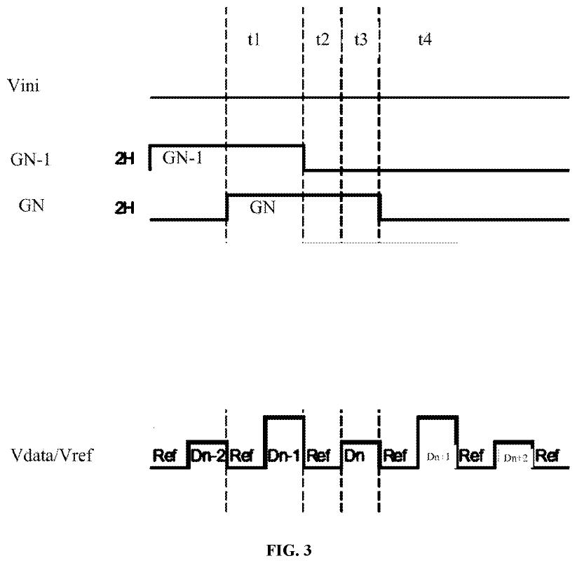

Referring to FIG. 3, it is a schematic diagram of an operation phase of the pixel unit P, and an operation process of the pixel unit P is described in detail through combination of FIG. 2 and FIG. 3.

In the initialization time period t1, the gate scanning signals provided by the gate scanning lines Gn and Gn−1 are both at a high level, and the initialization voltage Vini is provided to the anode terminal Anode of the light emitting element OLED, so as to perform initialization for the light emitting element OLED and the drive capacitor, thus ensuring that remaining electrical signals in the pixel unit P in a previous scanning cycle are discharged completely.

In the compensation time period t2, a compensation voltage needs to be provided to the anode terminal Anode of the light emitting element OLED, so as to compensate for offset of a threshold voltage Vth of each transistor in the pixel unit P and aging offset of the light emitting element OLED itself, so as to ensure the correct display of the pixel unit P for the current image data and consistency of the display of all pixel units P.

In the data loading time period t3, the image data Vdata to be displayed is loaded to the anode terminal Anode of the light emitting element OLED. In the above, icon symbol Vdata/Vref denotes that the image data Vdata and the reference voltage Vref are provided alternately in two adjacent time periods, and meanwhile, Dn−2, Dn−1, Dn, Dn+1, and Dn+2 denote image data provided to different rows.

In the light emitting time period t4, after the loading of the image data Vdata to be displayed is completed, the light emitting element OLED emits light according to the image data Vdata so as to perform the image display.

It should be noted that the initialization time period t1 and the compensation time period t2 of the pixel unit P in the n-th row in one scanning cycle and the data loading time period t3 and the light emitting time period t4 of the pixel unit P in the n−1-th row in the scanning cycle coincide in time.

Specifically, referring to FIG. 4, it is a schematic diagram of a circuit structure of a light emitting scanning drive unit EOAN in any scanning drive unit 10 as shown in FIG. 1, where N is a positive integer.

As shown in FIG. 4, the light emitting scanning drive unit EOA includes a pull-up control unit 11, a pull-up output unit 12, a pull-down control unit 13, and a pull-down output unit 14.

In the above, the pull-up control unit 11 is configured to receive the first clock signal ECKi, and transmit the high level to a pull-up node PU according to the first clock signal ECKi in one scanning cycle so as to control the pull-up node PU to be in a high-level state.

The pull-up output unit 12 is electrically connected to the pull-up node PU, and is in a conductive state when the pull-up node PU is in the high-level state, so as to transmit a high-level reference voltage VGH received from a high reference voltage terminal EVGH to the light emitting scanning terminal Oe.

The pull-down control unit 14, electrically connecting the pull-down node PD and the pull-up node PU, is configured to control the pull-up node PU to be in a low-level state and to control the pull-down node PD to be in the high-level state in each time period of two non-overlapping time periods in one scanning cycle.

Preferably, durations of the two non-overlapping time periods are different. In the above, to control the pull-up node PU to be in a low-level state and to control the pull-down node PD to be in the high-level state in each time period of two non-overlapping time periods in one scanning cycle means to simultaneously control the pull-up node PU to be in the low-level state and control the pull-down node PD to be in the high-level state in each time period of two non-overlapping time periods.

In the present embodiment, a high voltage reference state is that the voltage of the node is at a high level and is sufficient to drive a corresponding transistor to be in a conductive state, for example, VGH is 5 V, and a low voltage reference state is that the voltage of the node is a low voltage and is insufficient to maintain the transistor in a conductive state, for example, VGL is 0 V.

The pull-down output unit 13, electrically connected between the pull-down node PD and the light emitting scanning terminal Oe, is configured to output a low-level reference voltage VGL received from the low reference voltage terminal EVGL to the light emitting scanning terminal Oe when the pull-down node PD is in the high-level state. Thus, under corresponding control of the pull-down control unit 13, a pulse at a low level is output through the light emitting scanning terminal Oe in the two non-overlapping time periods.

In the present embodiment, as shown in FIG. 3 and FIG. 4, in the light emitting scanning signal output from the light emitting scanning drive unit EOA, two non-overlapping time periods in the low-level state in one scanning cycle are respectively the initialization time period t1 and the data loading time period t3 in sequence, and a duration of the initialization time period t1 is greater than that of the data loading time period t3.

As the light emitting scanning unit EOA can provide two non-overlapping low-level reference voltages in one scanning cycle, in the initialization time period t1, the third pixel transistor TP3 in the pixel unit P is in an off state, and even if the gate scanning signals provided by the high-level gate scanning lines Gn and Gn−1 are at a high level, the drive voltage terminal ELVDD in the pixel unit P connected to the third pixel transistor TP3 and the initialization voltage terminal Vinitial of the fourth pixel transistor TP4 are in a disconnected state, then the two cannot form a conductive path, thus effectively reducing the power consumption of each transistor and each capacitance element.

More specifically, as shown in FIG. 4:

the pull-up control unit 11 includes a first transistor M1, a gate and a drain of the first transistor M1 are electrically connected to each other and receive the first clock signal ECKi, and a source of the first transistor M1 is electrically connected to the pull-up node PU.

The pull-up output unit 12 includes a second transistor M2 and a first capacitor Cl, a gate of the second transistor M2 is electrically connected to the pull-up node PU, a drain of the second transistor M2 is electrically connected to the high reference voltage terminal EVGH so as to receive the high reference voltage VGH, and a source of the second transistor M2 is electrically connected to the light emitting scanning terminal Oe. The first capacitor C1 is electrically connected between the pull-up node PU and the light emitting scanning terminal Oe.

The pull-down output unit 13 includes a third transistor M3, a gate of the third transistor M3 is electrically connected to the pull-down node PD, a source of the third transistor M3 is electrically connected to the light emitting scanning terminal Oe, and a drain of the third transistor M3 is electrically connected to the low reference voltage terminal EVGL and receives the low-level reference voltage VGL.

The pull-down control unit 14 includes a fourth transistor M4, a fifth transistor M5, a sixth transistor M6, a seventh transistor M7, an eighth transistor M8, and a ninth transistor M9.

A gate and a drain of the fourth transistor M4 are electrically connected to each other and receive the second clock signal ECKBj, and a source of the fourth transistor M4 is electrically connected to the pull-up node PU.

A gate and a drain of the seventh transistor M7 are electrically connected to each other and receive the gate scanning signal corresponding to the gate scanning line GN, and a source of the seventh transistor M7 is electrically connected to the gate of the fifth transistor M5.

A drain of the fifth transistor M5 is electrically connected to the gate of the seventh transistor M7 and receives the gate scanning signal corresponding to the gate scanning line GN, and the drain of the fifth transistor M5 is electrically connected to the pull-down node PD.

A gate of the sixth transistor M6 receives the second clock signal ECKBj, a drain of the sixth transistor M6 is electrically connected to the low reference voltage terminal EVGL and receives the low-level reference voltage VGL, and a source of the sixth transistor M6 is electrically connected to the pull-down node PD.

A gate of the eighth transistor M8 receives the second clock signal ECKBj, a source of the eighth transistor M8 is electrically connected to the gate of the fifth transistor M5, and a drain of the eighth transistor M8 is electrically connected to the low reference voltage terminal EVGL and receives the low-level reference voltage VGL.

The second clock signal ECKBj cooperates with the fourth transistor M4, the sixth transistor M6, and the eighth transistor M8 for ensuring that the pull-up node PU is reliably in the high-level state when the pull-down node PD is in a low reference voltage state in the corresponding time period (compensation time period t2), so that the light emitting scanning terminal Oe accurately outputs the high reference voltage in the corresponding time period.

The gate scanning signal corresponding to the gate scanning line GN cooperates with the fifth transistor M5 and the seventh transistor M7 to ensure that the pull-down node PD is in a high reference voltage state in a corresponding time period.

A gate of the ninth transistor M9 is electrically connected to the pull-down node PD, a source of the ninth transistor M9 is electrically connected to the pull-up node PU, and a drain of the ninth transistor M9 is electrically connected to the low reference voltage terminal EVGL and receives the low-level reference voltage VGL. In the above, the ninth transistor M9 is configured to ensure that the pull-up node PU is reliably in the low-level state when the pull-down node PD is in the high reference voltage state, so that the light emitting scanning terminal Oe accurately outputs the low-level reference voltage in a corresponding time period.

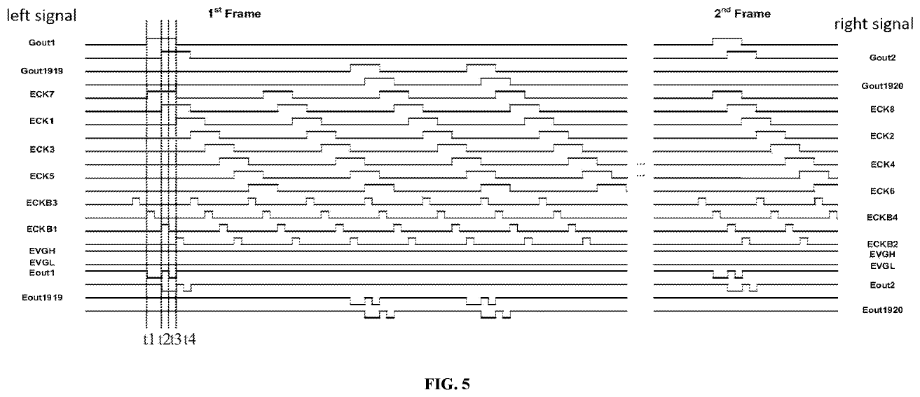

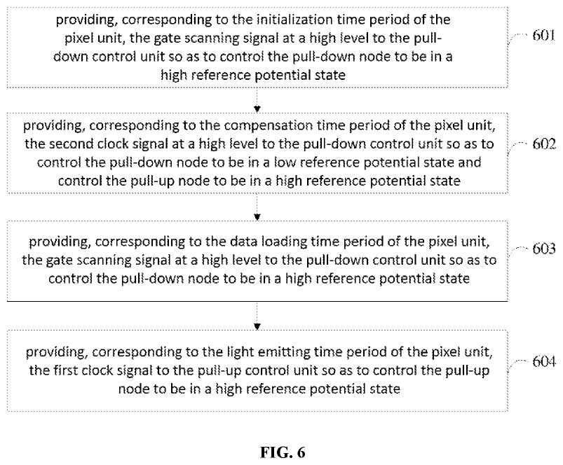

Referring to FIG. 5 and FIG. 6, FIG. 5 is an operation sequence diagram of all light emitting scanning drive units EOA shown in FIG. 1 and FIG. 4, and FIG. 6 is a schematic flow chart of outputting the light emitting scanning signal by all the light emitting scanning drive units EOA shown in FIG. 1 and FIG. 4. In the above, reference signs in the figures represent corresponding signals received in FIG. 4. In the present embodiment, the operation process of the light emitting scanning units is described by taking the light emitting scanning unit EOA1 arranged at a first position as an example.

In the above, when the light emitting scanning unit EOA1 is in a first-frame image scanning period 1stFrame,

in the initialization time period t1, the gate scanning signal output from the gate scanning line G1 is at a high level, the first clock signal ECK1 is at a low level, and the second clock signal ECKB1 is also at a low level, then the first transistor M1 in the pull-up control unit 11 is in an off state, and in the pull-down control unit 14, the seventh transistor M7 and the fifth transistor M5 are in a conductive state under the control of the gate scanning signal output from the gate scanning line G1, then the pull-down node PD is in a high-level state corresponding to the gate scanning signal output from the gate scanning line G1, the third transistor M3 in the pull-down output unit 13 is in a conductive state under the control of the high level of the pull-down node PD, thus, the low-level reference voltage VGL is transmitted to the light emitting scanning terminal Oe, and thus the light emitting scanning unit EOA1 outputs a low-level light emitting scanning signal in the initialization time period t1.

Meanwhile, in the pull-down control unit 14, the sixth transistor M6 and the eighth transistor M8 are in an off state under the control of the low level of the second clock signal ECKB1, and the ninth transistor M9 is in a conductive state under the control of high level of the pull-down node PD, thus, the low-level reference voltage VGL is transmitted to the pull-up node PU, so that the second transistor M2 in the pull-up unit 12 is in the off state, preventing the high-level reference voltage VGH from being transmitted to the light emitting scanning terminal Oe.

In the compensation time period t2, the gate scanning signal output from the gate scanning line G1 is at a high level, the first clock signal ECK1 is at a low level, and the second clock signal ECKB1 is at a high level. In the pull-down control unit 14, the fourth transistor M4 is in a conductive state, so that the pull-up node PU is pulled up to a high-level state, and correspondingly, the second transistor M2 in the pull-up unit 12 is in a conductive state, and the high-level reference voltage VGH is transmitted to the light emitting scanning terminal Oe, so that the light emitting scanning unit EOA1 outputs a high-level light emitting scanning signal in the compensation time period t2.

Meanwhile, the sixth transistor M6 and the eighth transistor M8 in the pull-down control unit 14 are in a conductive state under the control of high level of the second clock signal ECKB1, thus, the low-level reference voltage VGL is transmitted to the pull-down node PD, so that the pull-down node PD is in a low-level state, and the third transistor M3 in the pull-down output unit 13 is in an off state, thus transmission of the low-level reference voltage VGL to the light emitting scanning terminal Oe is stopped.

The ninth transistor M9 is in an off state under the control of the pull-down node PD.

In the data loading time period t3, the gate scanning signal output from the gate scanning line G1 is at a high level, the first clock signal ECK1 is at a low level, and the second clock signal ECKB1 is at a low level, then the same as the initialization time period t1, the low-level reference voltage VGL is transmitted to the light emitting scanning terminal Oe, that is, the light emitting scanning unit EOA1 outputs the low-level light emitting scanning signal in the data loading time period t3.

In the light emitting time period t4, the gate scanning signal output from the gate scanning line G1 is at a low level, the first clock signal ECK1 is at a high level, and the second clock signal ECKB1 is at a low level. The first transistor M1 in the pull-up control unit 11 is in a conductive state, then the pull-up node PU is pulled up to a high-level state, the second transistor M2 is in a conductive state, and the high-level reference voltage VGH is transmitted to the light emitting scanning terminal Oe, so that the light emitting scanning unit EOA1 outputs a high-level light emitting scanning signal in the light emitting time period t4.

Meanwhile, respective transistors in the pull-down control unit 14 and the pull-down output unit 13 are all in an off state, so as to stop transmitting the low-level reference voltage VGL to the light emitting scanning terminal Oe, ensuring that the light emitting scanning terminal Oe outputs an accurate high-level light emitting scanning signal.

So far, it can be clearly seen that the light emitting scanning signal output from the light emitting scanning unit EOA1 includes, in one scanning cycle, two low-level reference voltage phases spaced from each other for a certain period of time, that is, in one scanning cycle, the low level is output in the initialization time period t1 and the data loading time period t3, respectively, and a high level is output in the compensation time period t2 and the light emitting time period t4, so as to effectively ensure that the pixel unit P correctly loads the image data, and that the power consumption of the pixel unit can be effectively reduced.

A second-frame image scanning period 2stFrame is the same as the first-frame image scanning period 1stFrame in the operation process and display principle.

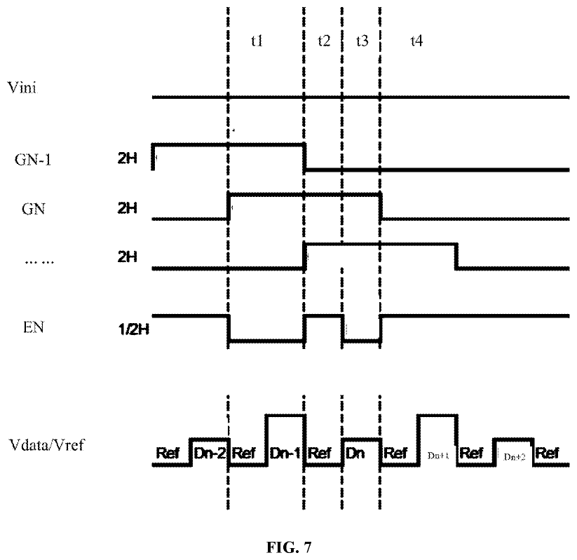

Referring to FIG. 2 and FIG. 7 together, FIG. 7 is an operation sequence diagram of the pixel unit P as shown in FIG. 2, wherein the pixel unit P is driven by the light emitting scanning signal output from the light emitting scanning drive unit EOAN as shown in FIG. 4, and specifically, as shown in FIG. 2 and FIG. 6:

in the initialization time period t1 of step 601, the gate scanning signals provided by the gate scanning lines Gn and Gn−1 are both high voltage, and the light emitting scanning signal provided by the light emitting scanning line En is at a low level, then in the pixel unit P, the transistor TP3 is in an off state, the transistors TP1 and TP4 are in a conductive state, and the initialization voltage Vinitial is provided to the anode terminal Anode of the light emitting element OLED, so as to perform initialization for the light emitting element OLED and the drive capacitor CP1. In this time period, the drive voltage terminal ELVDD and the initialization voltage terminal Vintial are in an electrically disconnected state therebetween, that is, no conductive path will be formed between the drive voltage terminal ELVDD and the initialization voltage terminal Vintial, then electronic components between the two endpoints will not be in a conductive operation state, but both in an operation state without power consumption, for example, when no conductive path is formed between the drive voltage terminal ELVDD and the initialization voltage terminal Vintial, the auxiliary capacitor CP2 is in a non-conductive state, so as to be in a non-operating state, thus, the power consumption of electronic components in the pixel unit P is reduced in this time period.

In the compensation time period t2 of step 602, the gate scanning signal provided by the gate scanning line Gn is at a high level, the gate scanning signal provided by the gate scanning line Gn−1 is at a low level, and the light emitting scanning signal provided by the light emitting scanning line En is at a high level. The first pixel transistor TP1 and the third pixel transistor TP3 in the pixel unit P are in a conductive state, and the fourth pixel transistor TP4 is in an off state, then in this time period, compensation for the offset of the threshold voltage Vth of each transistor in the pixel unit P and the aging offset of the light emitting element OLED itself is performed on the anode terminal Anode of the light emitting element OLED.

In the data loading time period t3 of step 603, the gate scanning signal provided by the gate scanning line Gn is at a high level, the gate scanning signal provided by the gate scanning line Gn−1 is at a low level, and the light emitting scanning signal provided by the light emitting scanning line En is at a low level. In the pixel unit P, the first pixel transistor TP1 is in a conductive state, the third pixel transistor TP3 and the fourth pixel transistor TP4 are in an off state, and the data signal Vdata is loaded to the anode terminal Anode of the light emitting element OLED through the first pixel transistor TP1, the second pixel transistor TP2, and the drive capacitor CP1.

In the light emitting time period t4 of step 604, the gate scanning signals provided by two adjacent gate scanning lines Gn−1 and Gn are at a low level, the light emitting scanning signal provided by the light emitting scanning line En is at a high level, and in the pixel unit P, the second pixel transistor TP2 and the third pixel transistor TP3 are in a conductive state, the first pixel transistor TP1 and the fourth pixel transistor TP4 are in an off state, and the driving voltage provided by the drive voltage terminal ELVDD drives the light emitting element OLED to emit light according to the data signal Vdata, so as to perform the image display.

It should be noted that the operation processes of the other pixel units are the same as that of the preceding pixel unit, and are not repeated herein again.

Specific examples are used herein to illustrate the principle and embodiments of the present disclosure. The description of the above embodiments is only intended to help understand the core idea of the present disclosure; and meanwhile, for those of ordinary skill in the art, according to the idea of the present disclosure, there will be changes in the specific embodiments and the scope of application. In summary, the contents of the present specification should not be construed as limitation to the present disclosure.

1. A light emitting scanning drive unit, wherein the light emitting scanning drive unit is configured to output a light emitting scanning signal, and comprises:
a pull-up control unit, configured to receive a first clock signal, and transmit a high-level reference voltage to a pull-up node according to the first clock signal in one scanning cycle so as to control the pull-up node to be in a high-level state;
a pull-up output unit, electrically connected to the pull-up node, and transmitting, when the pull-up node is in the high-level state, the high-level reference voltage received to a light emitting scanning terminal and outputting the high-level reference voltage as the light emitting scanning signal;
a pull-down control unit, electrically connecting a pull-down node and the pull-up node, and configured to control the pull-up node to be in a low-level state and to control the pull-down node to be in a high-level state in each time period of two non-overlapping time periods in one scanning cycle; and
a pull-down output unit, electrically connected to the pull-down node and the light emitting scanning terminal, and configured to, when the pull-down node is in the high-level state, output a low-level reference voltage received to the light emitting scanning terminal and output the low-level reference voltage as the light emitting scanning signal.

2. The light emitting scanning drive unit according to claim 1, wherein each scanning cycle comprises an initialization time period, a compensation time period, a data loading time period and a light emitting time period which are continuous in time without interruption, wherein the two non-overlapping time periods are the initialization time period and the data loading time period, and durations of the initialization time period and the data loading time period are different.

3. The light emitting scanning drive unit according to claim 2, wherein a duration of the initialization time period is greater than that of the data loading time period.

4. The light emitting scanning drive unit according to claim 2, wherein the first clock signal is provided to the pull-up control unit in the light emitting time period, and the pull-down control unit is further configured to receive a second clock signal in the compensation time period, and control the pull-up node to be in the high-level state according to the second clock signal.

5. The light emitting scanning drive unit according to claim 2, wherein the pull-up control unit comprises a first transistor, wherein a gate and a drain of the first transistor are electrically connected to each other and receive the first clock signal, and a source of the first transistor is electrically connected to the pull-up node.

6. The light emitting scanning drive unit according to claim 5, wherein the pull-up output unit comprises a second transistor and a first capacitor, wherein a gate of the second transistor is electrically connected to the pull-up node, a drain of the second transistor is electrically connected to a high reference voltage terminal so as to receive the high-level reference voltage, a source of the second transistor is electrically connected to the light emitting scanning terminal, and the first capacitor is electrically connected between the pull-up node and the light emitting scanning terminal.

7. The light emitting scanning drive unit according to claim 6, wherein the pull-down output unit comprises a third transistor, wherein a gate of the third transistor is electrically connected to the pull-down node, a source of the third transistor is electrically connected to the light emitting scanning terminal, and a drain of the third transistor is electrically connected to a low reference voltage terminal and receives the low-level reference voltage.

8. The light emitting scanning drive unit according to claim 7, wherein the pull-down control unit comprises a fourth transistor, a fifth transistor, a sixth transistor, a seventh transistor and an eighth transistor, wherein
a gate and a drain of the fourth transistor are electrically connected to each other and receive the second clock signal, and a source of the fourth transistor is electrically connected to the pull-up node,
a gate and a drain of the seventh transistor are electrically connected to each other and receive a gate scanning signal, and a source of the seventh transistor is electrically connected to a gate of the fifth transistor,
a drain of the fifth transistor is electrically connected to the gate of the seventh transistor, and the drain of the fifth transistor is electrically connected to the pull-down node,
a gate of the sixth transistor receives the second clock signal, a drain of the sixth transistor is electrically connected to the low reference voltage terminal and receives the low-level reference voltage, and a source of the sixth transistor is electrically connected to the pull-down node; and
a gate of the eighth transistor receives the second clock signal, a source of the eighth transistor is electrically connected to the gate of the fifth transistor, and a drain of the eighth transistor is electrically connected to the low reference voltage terminal and receives the low-level reference voltage.

9. The light emitting scanning drive unit according to claim 8, wherein the pull-down control unit further comprises a ninth transistor, wherein a gate of the ninth transistor is electrically connected to the pull-down node, a source of the ninth transistor is electrically connected to the pull-up node, and a drain of the ninth transistor is electrically connected to the low reference voltage terminal and receives the low-level reference voltage.

10. An array substrate, comprising a pixel unit and a scan drive circuit, wherein the scan drive circuit comprises a plurality of scanning drive units cascaded with each other, wherein a scanning drive unit comprises a gate scanning drive unit and the light emitting scanning drive unit according to claim 1, wherein the gate scanning drive unit is configured to output a gate scanning signal, and the pixel unit, driven by the gate scanning signal and the light emitting scanning signal, emits light for a data signal received and performs image display.

11. The array substrate according to claim 10, wherein the pixel unit comprises a first pixel transistor, a second pixel transistor, a third pixel transistor, a fourth pixel transistor and a drive capacitor, wherein
a gate of the first pixel transistor is electrically connected to a gate scanning line, a drain of the first pixel transistor is electrically connected to a data line so as to receive a data signal, and a source of the first pixel transistor is electrically connected to a gate of the second pixel transistor;
a gate of the third pixel transistor is electrically connected to a light emitting scanning line, a drain of the third pixel transistor is electrically connected to a drive voltage terminal, and a source of the third pixel transistor is electrically connected to a drain of the second pixel transistor;
a source of the second pixel transistor is electrically connected to an anode terminal of a light emitting element;
a gate of the four pixel transistor is electrically connected to another gate scanning line adjacent to the gate scanning line, a drain of the four pixel transistor is electrically connected to an initialization voltage terminal, and a source of the four pixel transistor is electrically connected to the anode terminal of the light emitting element; and
the drive capacitor is electrically connected between the anode terminal of the light emitting element and the gate of the second pixel transistor.

12. The array substrate according to claim 11, wherein the pixel unit further comprises an auxiliary capacitor, wherein the auxiliary capacitor is electrically connected between the anode terminal of the light emitting element and a high voltage drive terminal.

13. The array substrate according to claim 12, wherein in an initialization time period of one scanning cycle, the pixel unit receives gate scanning signals both being at a high level from two adjacent gate scanning lines, and receives the light emitting scanning signal at a low level from the light emitting scanning terminal, so as to control the first pixel transistor and the fourth pixel transistor to be in a conductive state, so as to perform initialization on the pixel unit, and the third pixel transistor is in an off state so as to ensure that the high voltage drive terminal and the initialization voltage terminal are electrically disconnected.

14. The array substrate according to claim 13, wherein
when the pixel unit is in a compensation time period, a gate scanning signal provided by the gate scanning line is at a high level, a gate scanning signal provided by another adjacent gate scanning line is at a low level, and a light emitting scanning signal provided by the light emitting scanning line is at a high level, so as to control the first pixel transistor and the third pixel transistor to be in a conductive state, and the fourth pixel transistor to be in an off state, to perform compensation for the pixel unit; and
when the pixel unit is in a data loading time period, a light emitting scanning signal provided by the light emitting scanning line is at low level, so as to control the first transistor to be in a conductive state, and the first pixel transistor and the fourth pixel transistor to be in an off state, so as to ensure that the data signal is loaded to the anode terminal of the light emitting element through the second pixel transistor.

15. The array substrate according to claim 14, wherein
when the pixel unit is in a light emitting time period, gate scanning signals provided by the two adjacent gate scanning lines are both at a low level, and a light emitting scanning signal provided by the light emitting scanning line is at a high level, so as to control the second pixel transistor and the third pixel transistor to be in a conductive state, and the first pixel transistor and the fourth pixel transistor to be in an off state, and drive the light emitting element to perform light emitting display from the drive voltage terminal in cooperation with the data signal.

16. The array substrate according to claim 15, wherein each scanning cycle comprises the initialization time period, the compensation time period, the data loading time period and the light emitting time period which are continuous in time without interruption.

17. A method for outputting a light emitting scanning signal with the light emitting scanning drive unit according to claim 1, comprising:
providing, corresponding to a initialization time period of a pixel unit, a gate scanning signal at a high level to the pull-down control unit so as to control the pull-down node to be in the high-level state, wherein when the pull-down node is in the high-level state, the pull-down output unit outputs the low-level reference voltage received to the light emitting scanning terminal;
providing, corresponding to a compensation time period of the pixel unit, a second clock signal at a high level to the pull-down control unit so as to control the pull-down node to be in the low-level state and control the pull-up node to be in the high-level state, wherein when the pull-up node is in a high-level state, the pull-up output unit transmits the high-level reference voltage to the light emitting scanning terminal;
providing, corresponding to a data loading time period of the pixel unit, a gate scanning signal at a high level to the pull-down control unit so as to control the pull-down node to be in the high-level state, wherein when the pull-down node is in the high-level state, the pull-down output unit outputs the low-level reference voltage received to the light emitting scanning terminal; and
providing, corresponding to a light emitting time period of the pixel unit, the first clock signal to the pull-up control unit so as to control the pull-up node to be in the high-level state, wherein when the pull-up node is in the high-level state, the pull-up output unit outputs the high-level reference voltage received to the light emitting scanning terminal.

18. The method for outputting a light emitting scanning signal according to claim 17, wherein corresponding to the compensation time period and the data loading time period of the pixel unit, the gate scanning signal is maintained at a high level, and corresponding to the light emitting time period of the pixel unit, the gate scanning signal is at a low level.
